(19) United States
(12) Patent Application Publication
(10) Pub. No.: US 2024/0326045 A1
(43) Pub. Date: Oct. 3, 2024

(54) FLUID FILTRATION CASSETTE ASSEMBLY

(71) Applicant: Donaldson Company, Inc., Bloomington, MN (US)

(72) Inventors: Jinxiang Zhou, Greenville, SC (US); Raymond S. Cleveland, Minneapolis, MN (US); Daniel P. Little, Eden Prairie, MN (US); Benjamin C. Druecke, Hudson, WI (US); Matthew P. Goertz, Bloomington, MN (US); Aflal Rahmathullah, Savage, MN (US)

(21) Appl. No.: 18/622,503

(22) Filed: Mar. 29, 2024

Related U.S. Application Data
(60) Provisional application No. 63/456,282, filed on Mar. 31, 2023.

(51) Int. Cl. B01L 3/00

(52) U.S. Cl. CPC B01L 3/50273; B01L 3/502753; B01L 2300/0681; B01L 2300/0829; B01L 2300/0838; B01L 2400/0406; B01L 2400/0487

(57) ABSTRACT

The present application discloses a cassette assembly including an inlet cassette plate, an outlet cassette plate, and a separation layer disposed therebetween. The inlet cassette plate defines an inlet flow path and an inlet channel extending therefrom. The outlet cassette plate is configured to be arranged in a stack with the inlet cassette plate and defines an outlet flow path and an outlet channel extending therefrom. The separation layer extends from a first lateral end to a second lateral end. The inlet flow path is configured to be in fluid communication with the outlet flow path through the separation layer. The inlet channel defines an effective inlet surface area of the separation layer and the outlet channel defines an effective outlet surface area of the separation layer. The effective inlet surface area defines a first width towards the first lateral end and a second width towards the second lateral end.

### RELATED APPLICATIONS

This application claims the benefit under 35 U.S.C. § 119 (e) of U.S. Provisional Patent Application No. 63/456,282 filed on Mar. 31, 2023 titled FLUID FILTRATION CASSETTE ASSEMBLY, which is hereby incorporated by reference in its entirety.

### TECHNOLOGICAL FIELD

The present disclosure is generally related to a filtration cassette assembly. More particularly, the present disclosure is related to a fluid filtration cassette that includes at least one of a flow guide, an optimized fluid inlet geometry, and an inlet retaining feature.

### BACKGROUND

Fluid filtration cassettes may be used, for example, in membrane chromatography, tangential flow filtration (TFF), various microfiltration applications, etc. As fluid flows from an inlet and through the cassette to an outlet, various forces and pressures may act on the fluid and the cassette.

It can be desirable to promote uniform fluid flow laterally across a first side of a separation layer disposed within the cassette assembly, axially through the separation layer, and laterally across an opposite side of the separation layer once the fluid has passed through the separation layer. Such uniform flow may improve fluid filtration. Uniform flow may also result in more consistent and more easily controlled pressures within the cassette assembly. Consequently, the fluid filtration cassette assembly may have an inlet channel that brings fluid to a separation layer in a manner which promotes uniform flow.

It can also be desirable to remove gases from the cassette assembly to promote consistent pressure and fluid flow during filtration.

### SUMMARY

The technology disclosed herein relates to a fluid filtration cassette assembly with at least one of: a flow guide, an optimized fluid inlet geometry, and an inlet retaining feature. Any one or more of the above features allows for the fluid filtration to be optimizable or adaptable to a variety of operating conditions and environments.

In one or more embodiments, the cassette assembly includes an inlet cassette plate. The inlet cassette plate defines an inlet flow path and an inlet channel extending from the inlet flow path. The cassette assembly further includes an outlet cassette plate. The outlet cassette plate is configured to be arranged in a stack with the inlet cassette plate. The outlet cassette plate defines an outlet flow path and an outlet channel extending from the outlet flow path. The cassette assembly further includes a separation layer disposed between the inlet cassette plate and the outlet cassette plate. The separation layer extends from a first lateral end to a second lateral end. The inlet flow path is configured to be in fluid communication with the outlet flow path through the separation layer to form an assembly flow path. The inlet channel defines an effective inlet surface area of the separation layer. The outlet channel defines an effective outlet surface area of the separation layer. The effective inlet surface area defines a first width towards the first lateral end and a second width towards the second lateral end. The first width is less than the second width.

Additionally or alternatively, the inlet channel extends from an inlet intermediate position between the first lateral end and the second lateral end towards the second lateral end. Additionally or alternatively, the outlet channel extends from an outlet intermediate position between the first lateral end and the second lateral end towards the first lateral end. Additionally or alternatively, the width of the effective inlet surface area tapers from the first width to the second width. Additionally or alternatively, the cassette assembly includes a flow guide positioned within the inlet channel towards the first lateral end. The flow guide defines the first width. Additionally or alternatively, the flow guide tapers from the first width to the second width. Additionally or alternatively, the inlet cassette plate defines the second width.

Additionally or alternatively, the inlet flow path has an inlet opening that defines an interface between the inlet flow path and the inlet channel. The inlet opening defines an elongate slot across the first width. Additionally or alternatively, the inlet flow path has an inlet opening that defines an interface between the inlet flow path and the inlet channel. The inlet opening is circular. Additionally or alternatively, the outlet flow path has an outlet opening that defines an interface between the outlet flow path and the outlet channel. The outlet opening defines an elongate slot across the first width. Additionally or alternatively, the outlet flow path has an outlet opening that defines an interface between the outlet flow path and the outlet channel. The outlet opening is circular.

Additionally or alternatively, the cassette assembly includes an assembly inlet. The inlet flow path defines an axial through-hole. The inlet cassette plate is configured to fluidically couple the assembly inlet and the inlet channel. Additionally or alternatively, the cassette assembly further includes an assembly outlet. The outlet flow path defines an axial through-hole. The outlet cassette plate is configured to fluidically couple the assembly outlet and the outlet channel.

Additionally or alternatively, the cassette assembly includes an inlet retaining feature configured to cover an inlet opening of the inlet flow path. The inlet opening defines an interface between the inlet flow path and the inlet channel. Additionally or alternatively, the cassette assembly includes an outlet retaining feature configured to cover an outlet opening of the outlet flow path. The outlet opening defines an interface between the outlet flow path and the outlet channel.

Additionally or alternatively, the cassette assembly includes a separation layer seal installed between the inlet cassette plate and the outlet cassette plate. The separation layer seal is in contact with the inlet cassette plate and the outlet cassette plate. The separation layer seal is configured to fluidically seal a perimeter region of the separation layer, a perimeter region of the inlet channel, and a perimeter region of the outlet channel. Additionally or alternatively, the separation layer seal includes an overmolded gasket.

Additionally or alternatively, the separation layer includes a membrane stack further including a plurality of membrane layers. The plurality of membrane layers includes at least 10 membrane layers. Additionally or alternatively, the separation layer has an effective inlet surface area defined by an effective length and an effective width. The effective length is at least 2.5 times the effective width.

Additionally or alternatively, the cassette assembly includes an outlet channel spacer positioned in the outlet channel. The outlet channel spacer is configured to accommodate fluid flow. Additionally or alternatively, the cassette assembly includes an inlet channel spacer positioned in the inlet channel. The inlet channel spacer is configured to accommodate fluid flow. Additionally or alternatively, at least one of the inlet channel spacer and the outlet channel spacer includes lateral ridges extending across the separation layer.

Additionally or alternatively, the outlet cassette plate includes an alignment feature and the inlet cassette plate includes a mating alignment feature. The alignment feature is laterally aligned with the mating alignment feature to operatively couple the outlet cassette plate and the inlet cassette plate.

Additionally or alternatively, the cassette assembly includes a fastener configured to operatively couple the inlet cassette plate and the outlet cassette plate. Additionally or alternatively, the fastener includes a bolt. The inlet cassette plate defines a first axial through-hole, and the outlet cassette plate defines a second axial through-hole. The first axial through-hole and the second axial through-hole are configured to laterally align to receive the bolt. The cassette assembly further includes a first nut configured to receive one end of the bolt and a second nut configured to receive an opposite end of the bolt. The first and second nuts are configured to apply a compression force to the cassette assembly.

Additionally or alternatively, the cassette assembly includes an attachment seal between the inlet cassette plate and the outlet cassette plate. The attachment seal extends laterally around and outside of a periphery of the separation layer.

In one or more embodiments, the cassette assembly includes an inlet cassette plate. The inlet cassette plate defines an inlet flow path, an inlet channel in fluid communication with the inlet flow path, and an inlet opening. The inlet opening defines an interface between the inlet flow path and the inlet channel. The cassette assembly includes an outlet cassette plate configured to be arranged in a stack with the inlet cassette plate. The outlet cassette plate defines an outlet flow path and an outlet channel in fluid communication with the outlet flow path. The cassette assembly includes a separation layer disposed between the inlet cassette plate and the outlet cassette plate. The separation layer extends from a first lateral end to a second lateral end. The inlet flow path is configured to be in fluid communication with the outlet flow path through the separation layer to form an assembly flow path. The cassette assembly includes an inlet retaining feature extending across the inlet opening of the inlet flow path.

Additionally or alternatively, the inlet channel extends from an inlet intermediate position between the first lateral end and the second lateral end towards the second lateral end. Additionally or alternatively, the outlet channel extends from an outlet intermediate position between the first lateral end and the second lateral end towards the first lateral end. Additionally or alternatively, the width of the effective inlet surface area tapers from the first width to the second width.

Additionally or alternatively, the cassette assembly includes a flow guide positioned within the inlet channel towards the first lateral end. The flow guide defines the first width. Additionally or alternatively, the flow guide tapers from the first width to the second width. Additionally or alternatively, the inlet cassette plate defines the second width.

Additionally or alternatively, the inlet flow path has an inlet opening. The inlet opening defines an interface between the inlet flow path and the inlet channel. The inlet opening defines an elongate slot across the first width. Additionally or alternatively, the inlet flow path has an inlet opening that defines an interface between the inlet flow path and the inlet channel, and the inlet opening is circular. Additionally or alternatively, the outlet flow path has an outlet opening. The outlet opening defines an interface between the outlet flow path and the outlet channel. The outlet opening defines an elongate slot across the first width. Additionally or alternatively, the outlet flow path has an outlet opening that defines an interface between the outlet flow path and the outlet channel, and the outlet opening is circular.

Additionally or alternatively, the cassette assembly includes an assembly inlet. The inlet flow path defines an axial through-hole. The inlet cassette plate is configured to fluidically couple the assembly inlet and the inlet channel. Additionally or alternatively, the cassette assembly includes an assembly outlet. The outlet flow path defines an axial through-hole. The outlet cassette plate is configured to fluidically couple the assembly outlet and the outlet channel. Additionally or alternatively, the cassette assembly includes an outlet retaining feature configured to cover an outlet opening of the outlet flow path. The outlet opening defines an interface between the outlet flow path and the outlet channel.

Additionally or alternatively, the cassette assembly includes a separation layer seal installed between the inlet cassette plate and the outlet cassette plate. The separation layer seal is in contact with the inlet cassette plate and the outlet cassette plate. The separation layer seal is configured to fluidically seal a perimeter region of the separation layer, a perimeter region of the inlet channel, and a perimeter region of the outlet channel. Additionally or alternatively, the separation layer seal includes an overmolded gasket. Additionally or alternatively, the separation layer includes a membrane stack. The membrane stack further includes a plurality of membrane layers. The plurality of membrane layers includes at least 10 membrane layers.

Additionally or alternatively, the separation layer has an effective inlet surface area defined by an effective length and an effective width. The effective length is at least 2.5 times the effective width.

Additionally or alternatively, the cassette assembly includes an outlet channel spacer positioned in the outlet channel. The outlet channel spacer is configured to accommodate fluid flow. Additionally or alternatively, the cassette assembly includes an inlet channel spacer positioned in the inlet channel. The inlet channel spacer is configured to accommodate fluid flow. Additionally or alternatively, at least one of the inlet channel spacer and the outlet channel spacer includes lateral ridges extending across the separation layer.

Additionally or alternatively, the outlet cassette plate includes an alignment feature and the inlet cassette plate includes a mating alignment feature. The alignment feature is laterally aligned with the mating alignment feature to operatively couple the outlet cassette plate and the inlet cassette plate.

Additionally or alternatively, the cassette assembly includes a fastener configured to operatively couple the inlet cassette plate and the outlet cassette plate. Additionally or alternatively, the fastener includes a bolt. The inlet cassette plate defines a first axial through-hole. The outlet cassette plate defines a second axial through-hole. The first axial through-hole and the second axial through-hole are configured to laterally align to receive the bolt. The cassette assembly further includes a first nut configured to receive one end of the bolt and a second nut configured to receive an opposite end of the bolt. The first and second nuts are configured to apply a compression force to the cassette assembly.

Additionally or alternatively, the cassette assembly includes an attachment seal between the inlet cassette plate and the outlet cassette plate. The attachment seal extends laterally around and outside of a periphery of the separation layer.

In one or more embodiments, the cassette assembly includes an inlet cassette plate. The inlet cassette plate defines an inlet flow path, an inlet channel in fluid communication with the inlet flow path, and an inlet opening. The inlet opening defines an interface between the inlet flow path and the inlet channel. The inlet opening is an elongate slot. The cassette assembly includes an outlet cassette plate configured to be arranged in a stack with the inlet cassette plate. The outlet cassette plate defines an outlet flow path, an outlet channel in fluid communication with the outlet flow path, and an outlet opening. The outlet opening defines an interface between the outlet flow path and the outlet channel. The cassette assembly includes a separation layer. The separation layer is disposed between the inlet cassette plate and the outlet cassette plate and extends from a first lateral end to a second lateral end. The inlet flow path is configured to be in fluid communication with the outlet flow path through the separation layer to form an assembly flow path. The inlet channel defines an effective inlet surface area of the separation layer. The outlet channel defines an effective outlet surface area of the separation layer. The inlet opening extends laterally along a width of the effective inlet surface area.

Additionally or alternatively, the inlet channel extends from an inlet intermediate position between the first lateral end and the second lateral end towards the second lateral end. Additionally or alternatively, the outlet channel extends from an outlet intermediate position between the first lateral end and the second lateral end towards the first lateral end. Additionally or alternatively, the width of the effective inlet surface area tapers from the first width to the second width.

Additionally or alternatively, the cassette assembly includes a flow guide positioned within the inlet channel towards the first lateral end. The flow guide defines the first width. Additionally or alternatively, the flow guide tapers from the first width to the second width. Additionally or alternatively, the inlet cassette plate defines the second width.

Additionally or alternatively, the outlet flow path has an outlet opening. The outlet opening defines an interface between the outlet flow path and the outlet channel. The outlet opening defines an elongate slot across the first width. Additionally or alternatively, the outlet flow path has an outlet opening that defines an interface between the outlet flow path and the outlet channel, and the outlet opening is circular.

Additionally or alternatively, the cassette assembly includes an assembly inlet. The inlet flow path defines an axial through-hole. The inlet cassette plate is configured to fluidically couple the assembly inlet and the inlet channel. Additionally or alternatively, the cassette assembly includes an assembly outlet. The outlet flow path defines an axial through-hole. The outlet cassette plate is configured to fluidically couple the assembly outlet and the outlet channel.

Additionally or alternatively, the cassette assembly includes an inlet retaining feature. The inlet retaining feature is configured to cover an inlet opening of the inlet flow path. The inlet opening defines an interface between the inlet flow path and the inlet channel. Additionally or alternatively, the cassette assembly includes an outlet retaining feature. The outlet retaining feature is configured to cover an outlet opening of the outlet flow path. The outlet opening defines an interface between the outlet flow path and the outlet channel.

Additionally or alternatively, the cassette assembly includes a separation layer seal installed between the inlet cassette plate and the outlet cassette plate. The separation layer seal is in contact with the inlet cassette plate and the outlet cassette plate. The separation layer seal is configured to fluidically seal a perimeter region of the separation layer, a perimeter region of the inlet channel, and a perimeter region of the outlet channel. Additionally or alternatively, the separation layer seal includes an overmolded gasket.

Additionally or alternatively, the separation layer includes a membrane stack further including a plurality of membrane layers. The plurality of membrane layers includes at least 10 membrane layers.

Additionally or alternatively, the separation layer has an effective inlet surface area defined by an effective length and an effective width. The effective length is at least 2.5 times the effective width.

Additionally or alternatively, the cassette assembly includes an outlet channel spacer positioned in the outlet channel. The outlet channel spacer is configured to accommodate fluid flow. Additionally or alternatively, the cassette assembly includes an inlet channel spacer positioned in the inlet channel. The inlet channel spacer is configured to accommodate fluid flow. Additionally or alternatively, at least one of the inlet channel spacer and the outlet channel spacer includes lateral ridges extending across the separation layer.

Additionally or alternatively, the outlet cassette plate includes an alignment feature and the inlet cassette plate includes a mating alignment feature. The alignment feature is laterally aligned with the mating alignment feature to operatively couple the outlet cassette plate and the inlet cassette plate.

Additionally or alternatively, the cassette assembly includes a fastener configured to operatively couple the inlet cassette plate and the outlet cassette plate. Additionally or alternatively, the fastener includes a bolt. The inlet cassette plate defines a first axial through-hole. The outlet cassette plate defines a second axial through-hole. The first axial through-hole and the second axial through-hole are configured to laterally align to receive the bolt. The cassette assembly further includes a first nut configured to receive one end of the bolt and a second nut configured to receive an opposite end of the bolt. The first and second nuts are configured to apply a compression force to the cassette assembly.

Additionally or alternatively, the cassette assembly includes an attachment seal between the inlet cassette plate and the outlet cassette plate. The attachment seal extends laterally around and outside of a periphery of the separation layer.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

FIG. 1 is a first perspective view of an example fluid filtration cassette assembly consistent with various embodiments.

FIG. 2 is an exploded perspective view consistent with the example of FIG. 1.

FIG. 3 is another exploded perspective view consistent with the example of FIGS. 1-2.

FIG. 4 is a perspective cross-section view consistent with the example of FIGS. 1-3.

FIG. 5 is a detail view of a cross-section of a portion of a cassette assembly consistent with the example of FIGS. 1-4.

FIG. 6 is a first perspective view of an example fluid filtration cassette assembly consistent with various embodiments.

FIG. 7 a perspective cross-section view consistent with the example of FIG. 5.

FIG. 8 is another perspective cross-section view consistent with the example of FIGS. 5-6.

FIG. 9 is a facing view of an example channel spacer consistent with some examples.

FIG. 10 is a partial exploded view of an example cassette assembly consistent with some examples.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), fluid conduits such as tubing, cassette plates, and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

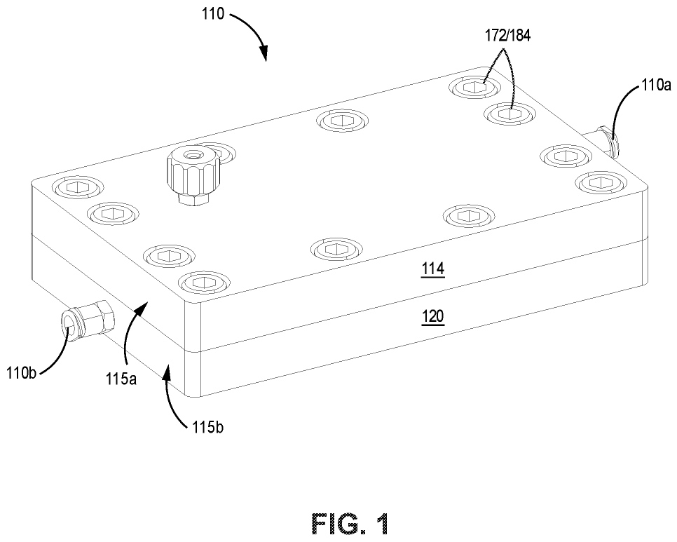

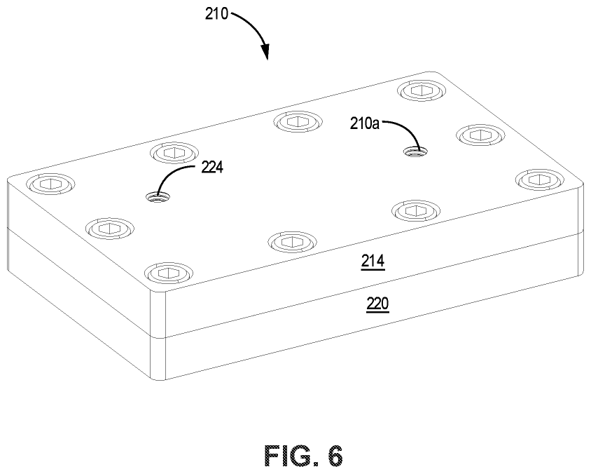

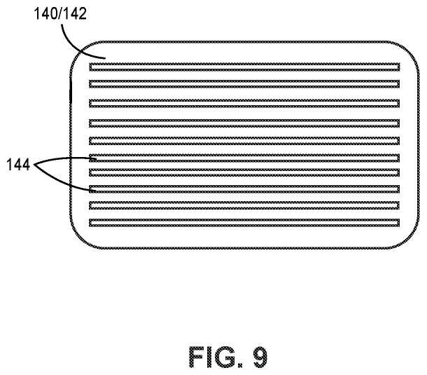

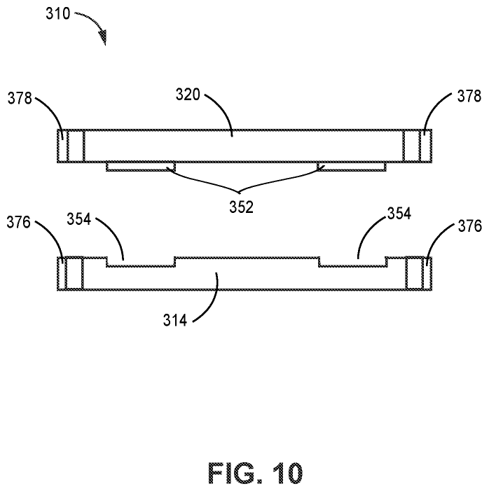

Cassette assemblies consistent with the technology disclosed herein can have a variety of different configurations. FIGS. 1-5 depict one example embodiment of a cassette assembly 110, and FIGS. 6-8 depict another example embodiment of a cassette assembly 210. FIGS. 9-10 depict elements which may be applicable to any example embodiment. FIGS. 1-5 can be viewed together with the following description. The cassette assembly 110 is generally configured to filter a fluid that is passed therethrough. The cassette assembly 110 generally has an inlet cassette plate 114, an outlet cassette plate 120, and a separation layer 130. The cassette assembly 110 may be configured to filter fluid passing therethrough. The present disclosure does not limit the flow direction to any specific orientation.

As illustrated in FIGS. 1-3, the cassette assembly 110 has an inlet cassette plate 114, an outlet cassette plate 120, and a separation layer 130 disposed between the inlet cassette plate 114 and the outlet cassette plate 120. The outlet cassette plate 120 can be configured to be arranged in a stack with the inlet cassette plate 114.

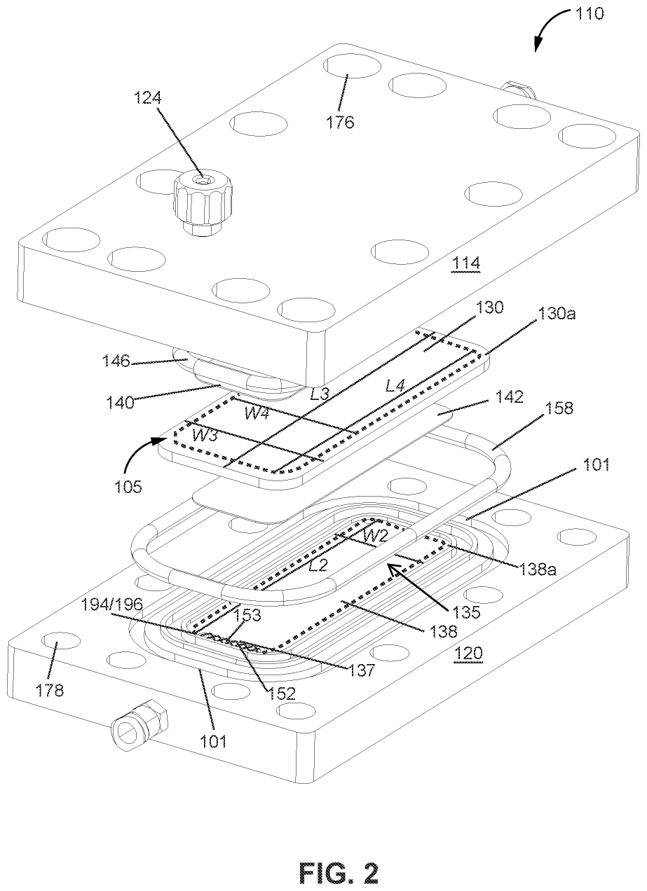

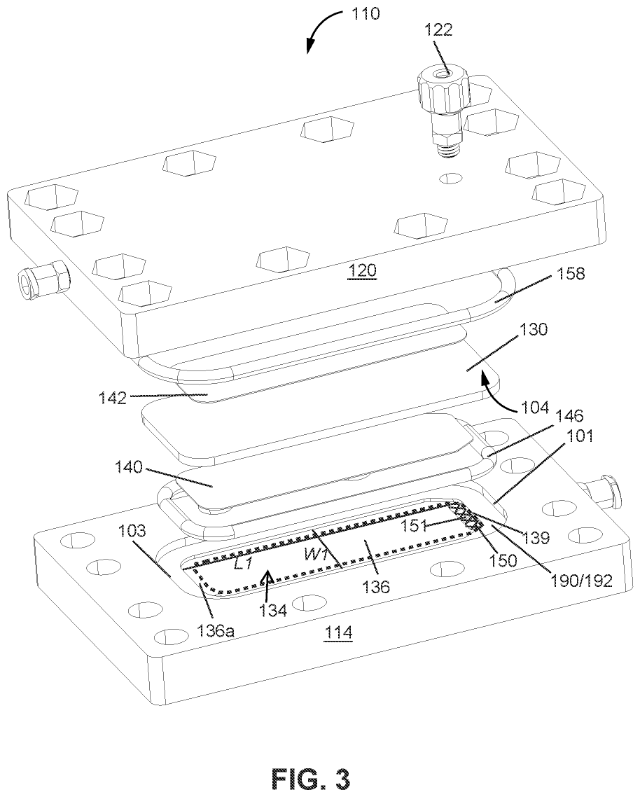

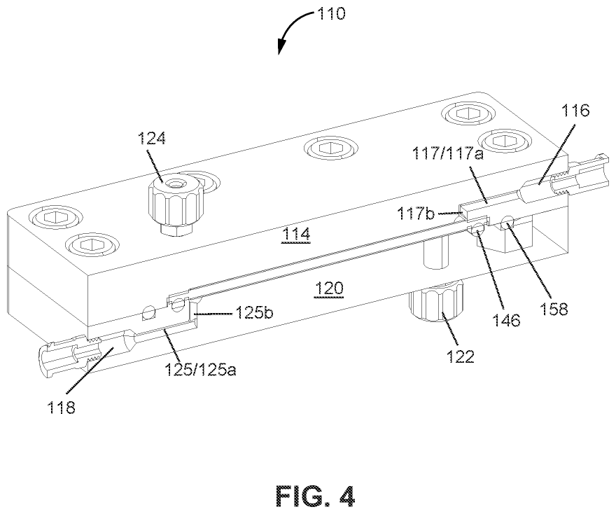

The inlet cassette plate 114 can define an inlet flow path 116 (particularly visible in FIG. 4). The inlet flow path 116 can be positioned towards a first lateral end 101 (FIGS. 2-3). The inlet cassette plate 114 can define an inlet cassette vent 124 (FIGS. 2, 4). The inlet flow path 116 defines a path for inlet fluid flow from an assembly inlet 110a (FIG. 1) into the inlet cassette plate 114 during a fluid filtration application. The inlet cassette vent 124 selectively defines a path for gas to vent out of the inlet cassette plate 114 during a fluid filtration application. The inlet cassette vent 124 may be open or closed to an ambient environment. The inlet flow path 116 can extend axially through the inlet cassette plate 114. The inlet cassette vent 124 can extend axially through the inlet cassette plate 114.

The outlet cassette plate 120 of each cassette assembly 110 can define an outlet flow path 118 (FIG. 4). The outlet flow path 118 can be positioned towards a second lateral end 103 (FIG. 2-3). The outlet cassette plate 120 can define an outlet cassette vent 122 (FIGS. 3-4). The outlet flow path 118 defines a path for outlet fluid flow from an assembly outlet 110b during a fluid filtration application. The outlet cassette vent 122 defines a path for gas to vent out of the outlet cassette plate 120 during a fluid filtration application. The outlet flow path 118 can extend axially through the outlet cassette plate 120. The outlet cassette vent 122 can extend axially through the outlet cassette plate 120. The outlet cassette vent 122 can be open or closed to the ambient environment. The inlet flow path 116 can be generally configured for fluid communication with the outlet flow path 118.

In various embodiments, the inlet flow path 116 and the outlet flow path 118 are in fluid communication via the separation layer 130 of the cassette assembly 110. The separation layer 130 is disposed between the inlet cassette plate 114 and the outlet cassette plate 120. The separation layer 130 can extend from the first lateral end 101 to the second lateral end 103. The separation layer 130 can define a total inlet surface area 104 (FIG. 2) and a total outlet surface area 105 (FIG. 3).

The separation layer 130 is generally configured to filter a fluid stream flowing from the inlet flow path 116 to the outlet flow path 118. The separation layer is configured to separate at least one component in the fluid stream from the fluid stream. Such separation may be realized through one or more of the following processes: chemical binding, binding of biological molecules, particle capture, absorption, adsorption, etc., as the fluid flows along and/or through the separation layer. The separation layer may include a single layer or a plurality of layers. The separation layer 130 is a fibrous mass in some embodiments. In some embodiments the separation layer 130 can be a particulate mass. The separation layer 130 is a single membrane in some embodiments. The separation layer 130 is a membrane stack in some embodiments. A membrane stack may include a plurality of membranes which are consecutively layered in the axial direction. The inlet flow path 116 can be configured to be in fluid communication with the outlet flow path 118 through the separation layer 130.

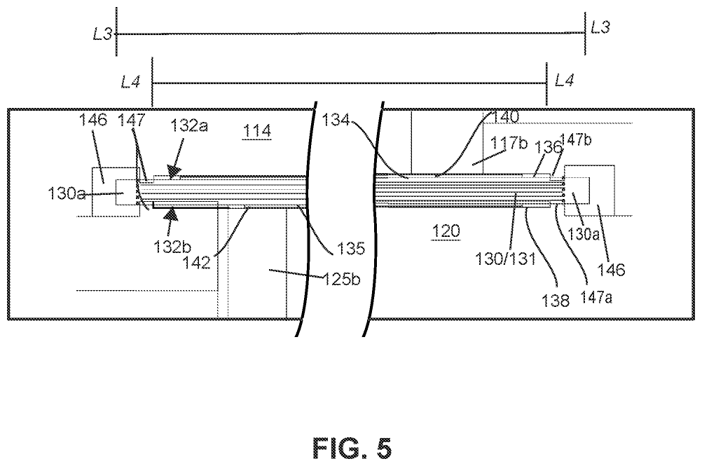

In embodiments where the separation layer 130 includes a membrane stack, the separation layer 130 can include a plurality of membrane layers 131 (shown in FIG. 5). The plurality of membrane layers 131 can be between 1 and 50 membrane layers 131. In embodiments, the plurality of membrane layers 131 can include at least 10 membrane layers 131. In alternative embodiments, the plurality of membrane layers 131 can include at least 5, at least, 15, at least 19, at least 20, at least 30, at least 40, or at least 50 membrane layers 131, etc. In alternative embodiments, the plurality of membrane layers 131 can include less than 50, less than 45, less than 35, less than 25, less than 17, less than 9, less than 4 membrane layers 131 etc.

The membrane layers 131 can be constructed of a variety of different materials and combinations of materials. In various embodiments the membrane layers 131 incorporate a breathable membrane, such as polytetrafluoroethylene (PTFE) or other types of breathable membranes. The membrane layers 131 can be a laminate or composite that includes a breathable membrane, such as a PTFE laminated to a woven or non-woven support layer. In some embodiments the membrane layers 131 incorporate a microporous substrate. In some embodiments each of the membrane layers 131 is constructed of the same or a similar material. In some embodiments one or more of the membrane layers 131 are constructed of a different material than other membrane layers 131.

FIGS. 3-4 illustrate a detail view of a cross-section of a cassette assembly 110 consistent with FIGS. 1-2. The cassette assembly 110 can further define an inlet channel 136 and an outlet channel 138 (as illustrated in FIGS. 2-3). The inlet channel 136 generally defines a path for fluid flow from the inlet flow path 116 (FIG. 3) along a first lateral surface 134 of the separation layer 130. The outlet channel 138 generally defines a path for fluid flow along a second lateral surface 135 of the separation layer 130, which is opposite the first lateral surface 134. The outlet channel 138 extends from the separation layer 130 to the outlet flow path 118 (FIG. 2).

The inlet channel 136 can extend from the inlet flow path 116. The inlet channel 136 can define an effective inlet surface area 132a of the separation layer 130. The “effective inlet surface area” 132a is defined as the surface area of the upstream surface of the separation layer 130, which is the first lateral surface 134, that is in fluid communication with the inlet channel 136. The effective inlet surface area 132a is partially defined by an effective length L4 (illustrated in FIG. 3). Conversely, the total length of the separation layer 130 is defined by L3 (FIGS. 2 and 5). The difference between 1.3 and 1.4 may be a result of features obstructing fluid flow through portions of the surfaces separation layer, such as a separation layer seal 146 (discussed further herein) or structures defined by the cassette plates 114, 120. The inlet channel 136 can extend laterally from the inlet flow path 116. The inlet channel 136 can extend axially between the inlet cassette plate 114 and the effective inlet surface area 132a of the separation layer 130. In some embodiments, the inlet channel 136 can have an axial depth that accommodates axial expansion of the separation layer 130 resulting from fluid flow through the separation layer 130 with a portion of the axial depth remaining clear of the separation layer 130 to accommodate fluid flow. In embodiments with a membrane stack, for example, the inlet channel 136 can be sized depending on, for example, the number of membrane layers 131, the material of the membrane layers 131, the desired fluid flow rate through the assembly 110, etc.

The effective inlet surface area 132a can define a first width towards the first lateral end 101. The effective inlet surface area 132a can define a second width towards the second lateral end 103. The inlet cassette plate 114 can define the first width. The inlet cassette plate 114 can define the second width. In some embodiments, the first width is less than the second width (as illustrated in FIG. 3). In alternative embodiments (not shown), the first width and the second width may be substantially the same, or the first width may be greater than the second width. In further alternative embodiments, the width of the effective inlet surface area 132a can taper from the first width to the second width, and vice versa.

The outlet channel 138 can extend from the outlet flow path 118. The outlet channel 138 can define an effective outlet surface area 132b of the separation layer 130. The “effective outlet surface area” is defined as the surface area of the downstream surface of the separation layer 130, which is the second lateral surface 135, that is in fluid communication with the outlet channel 138. The outlet channel 138 can extend laterally towards the outlet flow path 118. The outlet channel 138 can be in fluid communication with the outlet flow path 118. The outlet channel 138 can extend axially between the effective outlet surface area 132b of the separation layer 130 and the outlet cassette plate 120. In some embodiments, the outlet channel 138 can have an axial depth that accommodates axial expansion of the separation layer 130 resulting from fluid flow through the separation layer 130 with a portion of the axial depth remaining clear of the separation layer 130 to accommodate fluid flow. In embodiments with a membrane stack, for example, the outlet channel 138 can be sized depending on, for example, the number of membrane layers 131, the material of the membrane layers 131, the desired fluid flow rate through the assembly 110, etc.

In some embodiments, the inlet channel 136 can be defined by at least one of the inlet cassette plate 114, the separation layer 130, the effective inlet surface area 132a, and the inlet flow path 116. The outlet channel 138 can be defined by at least one of the outlet cassette plate 120, the separation layer 130, the effective outlet surface area 132b, and the outlet flow path 118. In some embodiments, the channels 136, 138 may be defined by any combination of the listed components, and additionally can be defined by one or more seals, discussed further herein.

The inlet channel 136 can extend from an inlet intermediate position 139 towards the second lateral end 103. The inlet intermediate position 139 can be between the first lateral end 101 and the second lateral end 103. The outlet channel 138 can extend from an outlet intermediate position 137 towards the first lateral end 101. The outlet intermediate position 137 can be between the first lateral end 101 and the second lateral end 103.

The inlet cassette plate 114 can further define an inlet flow guide 190 (FIG. 3). The inlet flow guide 190 may advantageously reduce or prevent backflow. Thus, the inlet flow guide 190 may advantageously improve fluid flow uniformity across the entirety of the effective area of the separation layer 130. The inlet flow guide 190 can be positioned within the inlet channel 136 at the first lateral end 101. The inlet flow guide 190 can define the first width. The inlet flow guide 190 can taper from the first width to the second width, and vice versa.

The inlet flow guide 190 can be configured to fluidically seal an inlet backflow region 192 of the inlet cassette plate 114. The inlet backflow region 192 can include a volume of an inlet channel (discussed further herein) extending laterally outwards from the inlet flow path 116. The inlet flow guide 190 can be a chamfered wall or body (FIG. 3) which fluidically seals the inlet backflow region 192 separate from the effective inlet surface area (FIG. 3).

The outlet cassette plate 120 can further define an outlet flow guide 194. The outlet cassette plate 120 can define the first width. The outlet cassette plate 120 can define the second width. The outlet flow guide 194 may advantageously reduce or prevent backflow mixing, where the fluid in the cassette does not flow laterally across an opposite side of the separation layer 130 once the fluid has passed through the separation layer 130. Thus, the outlet flow guide 194 may advantageously improve fluid flow uniformity across the entirety of the effective area of the separation layer 130. The outlet flow guide 194 can be positioned within the outlet channel 138 at the second lateral end 103. The outlet flow guide 194 can define the second width. The outlet flow guide 194 can taper from the first width to the second width, and vice versa.

The outlet flow guide 194 can be configured to fluidically seal an outlet backflow region 196 of the outlet cassette plate 120. The outlet backflow region 196 can include a volume of an outlet channel (discussed further herein) extending laterally outwards from the outlet flow path 118. The outlet flow guide 194 can be a chamfered wall or body (not shown) which fluidically seals the outlet backflow region 196 separate from the effective outlet surface area (FIG. 2).

The cassette assembly 110 may further include an assembly inlet 110a and an assembly outlet 110b. The inlet cassette plate 114 can be configured to fluidically couple the assembly inlet 110a and the inlet channel 136. The outlet cassette plate 120 can be configured to fluidically couple the assembly outlet 110b and the outlet channel 138.

The cassette assembly 110 can further include an inlet flow path extension 117 (e.g., 117a, 117b) and an outlet flow path extension 125 (e.g., 125a, 125b), as illustrated in FIG. 4. These extensions are configured to fluidically couple the inlet and outlet flow paths to the inlet and outlet channels, respectively. The inlet flow path extension 117 can be defined by the inlet cassette plate 114. The inlet flow path extension 117 can be configured to fluidically couple the inlet flow path 116 and the inlet channel 136. The inlet flow path extension 117 can include a first portion 117a and a second portion 117b (see FIG. 4). The first portion 117a can extend laterally from the inlet flow path 116 towards the inlet channel 136. In the current example, the second portion 117b extends axially from the first portion 117a to the inlet channel 136. The second portion 117b can be in fluid communication with the inlet channel 136 towards one lateral end of the inlet channel. In some embodiments, the second portion 117b can be in fluid communication with the inlet channel 136 at one lateral end of the inlet channel 136.

The outlet flow path extension 125 can be defined by the outlet cassette plate 120. The outlet flow path extension 125 can fluidically couple the outlet flow path 118 and the outlet channel 138 (FIG. 4). The outlet flow path extension 125 can include a first portion 125a and a second portion 125b. The first portion 125a can extend axially from the outlet channel 138 to the second portion 125b. The second portion 125b can extend laterally from the first portion 125a to the outlet flow path 118. The first portion 125a can be fluidically coupled to the outlet channel 138 towards the opposite end of the effective length L4 (illustrated in FIG. 5) of the separation layer 130 relative to the inlet extension first portion 117a.

In alternative embodiments, the extensions do not define 90-degree segments relative to each other or the corresponding fluid flow path as shown and can instead define one or more curved segments. In further alternative embodiments, the inlet extension is a single segment that extends at an oblique angle from the inlet flow path 116 to the inlet channel 136 such that the inlet extension is not orthogonal to the inlet flow path 116 or the inlet channel 136. Similarly, the outlet extension 125 may define a single or multiple segments where at least one segment is curved. In some embodiments the outlet extension is a single segment that defines an oblique angle and extends from the outlet channel 138 to the outlet flow path 118 such that the outlet extension is not orthogonal to the outlet flow path 118 or the outlet channel 138.

The second portion 117b can extend laterally along at least a portion of the width W1 (as illustrated in FIG. 3) of the inlet channel 136. This may advantageously improve fluid flow uniformity across the entirety of the effective area of the separation layer 130. Similarly, in this example, the first portion 125a can extend laterally along at least a portion of the width W2 of the outlet channel 138 (as illustrated in FIG. 2). Such a configuration may advantageously improve fluid flow uniformity across the entirety of the effective area of the separation layer 130. Alternate examples are possible where one or both of the second portion 117b of the inlet flow path extension and the first portion 125a of the outlet flow path extension define an opening having a circular shape rather than an elongate slot.

The shape of the open of the second portion 117b of the inlet flow path extension and the first portion 125a of the outlet flow path extension may be optimized for a specific fluid filtration application. The inlet flow path 116 can define an inlet opening 151 (FIG. 3) into the inlet channel 136. The inlet opening 151 can define an interface between the inlet flow path 116 and the inlet channel 136. The geometry of the inlet opening 151 may be any shape which effectively allows fluid flow through the cassette assembly 110 (e.g., circular, ovate, square, rectangular, hexagonal, elongate slot, etc.). The geometry of the inlet opening 151 may be optimized to advantageously improve fluid flow uniformity across the entirety of the effective area of the separation layer 130. The inlet opening 151 can define an elongate slot along the first width. The inlet opening 151 can extend laterally along a width of the effective inlet surface area 132a. The inlet opening 151 can be circular. Preliminary testing suggests that using an elongate slot geometry instead of a circular hole geometry in some implementations results in better flow distribution and flow uniformity across the entirety of the effective surface area of the separation layer 130, at least because an elongate slot provides better mixing of fluid, and lower pressures within the cassette assembly 110. However, using a smaller geometry may advantageously result in less overall volume of fluid within the cassette assembly 110. Thus, the geometry may be optimized for the fluid filtration application at hand.

The outlet flow path 118 can define an outlet opening 153 (FIG. 2) into the outlet channel 138. The outlet opening 153 can define an interface between the outlet flow path 118 and the outlet channel 138. The geometry of the outlet opening 153 may be any shape which effectively allows fluid flow through the cassette assembly 110 (e.g., circular, ovate, square, rectangular, hexagonal, elongate slot, etc.). The outlet opening 153 can define an elongate slot along a second width. The outlet opening 153 can extend laterally along a width of the effective outlet surface area 132b. The outlet opening 153 can be circular. The geometry of the outlet opening 153 may be optimized to advantageously improve fluid flow uniformity across the entirety of the effective area of the separation layer 130. Preliminary testing suggests that using an elongate slot geometry instead of a circular hole geometry in some implementations results in better flow distribution and flow uniformity across the entirety of the effective surface area of the separation layer 130, at least because an elongate slot provides better mixing of fluid, and lower pressures within the cassette assembly 110. However, using a smaller geometry may advantageously result in less overall volume of fluid within the cassette assembly 110. Thus, the geometry may be optimized for the fluid filtration application at hand.

The inlet cassette plate 114 and the outlet cassette plate 120 can be constructed of a variety of different materials and combinations of materials. In some embodiments, one or both of the cassette plates 114, 120 is plastic. In other embodiments, one or both of the cassette plates 114, 120 is metal. In one example, one or both of the cassette plates 114, 120 are injection-molded, 3D printed, machined, or combinations thereof. In some embodiments the inlet cassette plate 114 is constructed of the same material as the outlet cassette plate 120. In some other embodiments the inlet cassette plate 114 is constructed of a different material than the outlet cassette plate 120.

FIG. 9 illustrates a laterally facing view of an example channel spacer, which may be inserted into the inlet and/or outlet channels 136, 138 to ensure, for example, that the separation layer 130 does not expand into and block the channels. The cassette assembly 110 can further include one or more channel spacers 140, 142 that are each configured to be received by the inlet channel 136 and/or the outlet channel 138. In the current example, the cassette assembly 110 has an inlet channel spacer 140 and an outlet channel spacer 142 (as illustrated in FIGS. 2 and 6). The inlet channel spacer 140 is generally configured to retain a minimum axial depth of the inlet channel 136 to maintain fluid flow along the inlet channel 136. As mentioned above, the axial depth of the inlet channel 136 may be reduced upon system use due to separation layer expansion, for example, and the inlet channel spacer 140 may advantageously oppose such expansion. The inlet channel spacer 140 can be positioned in the inlet channel 136. The inlet channel spacer 140 is positioned between the inlet cassette plate 114 and the separation layer 130. In some embodiments, the inlet channel spacer 140 abuts the inlet cassette plate 114 and the separation layer 130.

The cassette assembly 110 can further include an outlet channel spacer 142. The outlet channel spacer 142 is generally configured to retain a minimum axial depth of the outlet channel 138 to accommodate fluid flow along the outlet channel 138. The axial depth of the outlet channel 138 may be reduced upon system use due to separation layer expansion, and the outlet channel spacer 142 may advantageously oppose such expansion. The outlet channel spacer 142 can be positioned in the outlet channel 138. The outlet channel spacer 142 is positioned between the outlet cassette plate 120 and the separation layer 130. In some embodiments, the outlet channel spacer 142 abuts the outlet cassette plate 120 and the separation layer 130.

The inlet channel spacer 140 and/or the outlet channel spacer 142 may be constructed of a variety of different materials and combinations of materials. In some embodiments, the spacer 140, 142 is plastic. The spacer can be a woven or non-woven material such as a scrim layer. In other embodiments, the spacer 140, 142 is a metal. In one example, the spacer 140, 142 is injection-molded, 3D printed or the like. The spacer 140, 142 can be constructed of an elastomeric material such as, for example, rubber, silicone, polyurethane, or other elastomeric materials. The spacer 140, 142 can be retained with friction and/or compression forces. Such friction forces can be among, for example, between the spacer 140, 142 and the separation layer 130, and between the spacer 140, 142 and the corresponding cassette plate 114, 120.

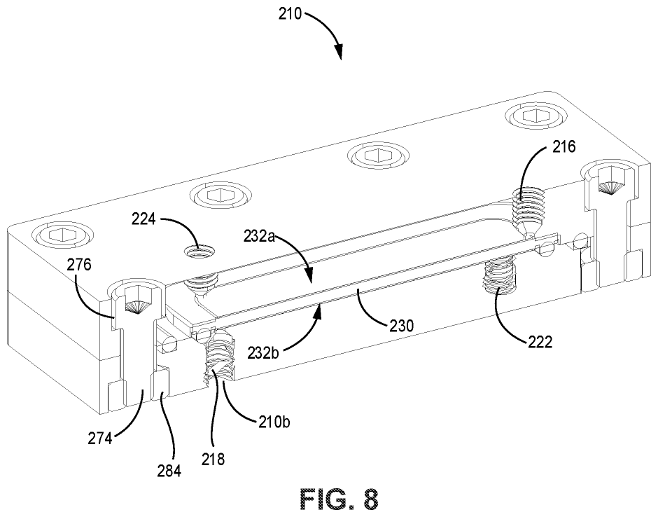

The channel spacers 140, 142 generally define lateral and axial openings to accommodate fluid flow through the channel spacers 140, 142 to the separation layer 130. In some embodiments, at least one of the inlet channel spacer 140 and the outlet channel spacer 142 can include lateral ridges 144 extending across the separation layer 130, an example of which is illustrated in FIG. 8. The lateral ridges 144 are generally configured to define a structure to retain the axial depth of the respective channel for fluid flow. The lateral ridges 144 may advantageously provide rigidity to the respective spacer. The lateral ridges 144 may further advantageously guide fluid flow across the respective surface area of the separation layer 130.

The lateral ridges 144 may extend laterally along at least a portion of the channel length of the respective channel within which the spacer is positioned. The lateral ridges 144 may extend axially between the separation layer 130 and the adjacent cassette plate.

In some embodiments, the cassette assembly 110 includes at least one of an inlet retaining feature 150 and an outlet retaining feature 152, as illustrated in FIGS. 2-3. The inlet and outlet retaining features 150, 152 may advantageously prevent the separation layer 130 from deforming into the inlet flow path 116 and the outlet flow path 118, respectively. The inlet and outlet retaining features 150, 152 may not be configured to cover as much of the inlet and outlet flow paths 116, 118, respectively, compared to the one or more channel spacers 140, 142, which may be configured to cover more of the inlet and outlet flow paths 116, 118, respectively. In some embodiments, the cassette assembly 110 may include the one or more channel spacers 140, 142 and the one or more retaining features 150, 152. In alternative embodiments, the cassette assembly 110 may include only the channel spacers 140, 142 without the retaining features 150, 152. In further alternative embodiments, the cassette assembly 110 may include only the retaining features 150, 152, without the channel spacers 140, 142. The channel spacers 140, 142 may not prevent such deformation of the separation layer 130 to an optimized extent, and instead may advantageously provide flow distribution. In embodiments with both the channel spacers 140, 142 and the retaining features 150, 152, the channel spacers 140, 142 may or may not laterally align, or overlay, the retaining features 150, 152.

The inlet retaining feature 150 may be configured to cover an inlet opening 151 of the inlet flow path 116. The inlet retaining feature 150 may extend across the inlet opening 151 of the inlet flow path 116. The inlet opening 151 of the inlet flow path 116 may define an interface between the inlet flow path 116 and the inlet channel 136. The interface may be two-dimensional, and additionally may or may not be planar. For example, in some embodiments (and as illustrated), the interface may be substantially planar and may be substantially parallel to the separation layer 130. In alternative embodiments (not shown), the interface may be non-planar.

The outlet retaining feature 152 may be configured to cover an outlet opening 153 of the outlet flow path 118. The outlet retaining feature 152 may extend across the outlet opening 153 of the outlet flow path 118. The outlet opening 153 of the outlet flow path 118 may define an interface between the outlet flow path 118 and the outlet channel 138. The interface may be two-dimensional, and additionally may or may not be planar. For example, in some embodiments (and as illustrated), the interface may be substantially planar and may be substantially parallel to the separation layer 130. In alternative embodiments (not shown), the interface may be non-planar.

Preliminary testing suggests that using both the inlet retaining feature 150 and the outlet retaining feature 152 in some implementations results in better flow distribution and flow uniformity across the entirety of the effective surface area of the separation layer 130 and allows for the direction of the flow to be reversed at any time without undesirable expansion of the separation layer 130 into the inlet or outlet flow paths 116, 118.

The inlet and outlet retaining features 150, 152 can be constructed of a variety of different materials and combinations of materials. In some embodiments, one or both of the retaining features 150, 152 is plastic and includes perforations therethrough for fluid flow. In other embodiments, one or both of the retaining features 150, 152 is metal and includes perforations therethrough for fluid flow. For example, in one embodiment, the inlet and/or outlet retaining features 150, 152 may be constructed of stainless steel. In one example, one or both of the retaining features 150, 152 are injection-molded, 3D printed, machined, or combinations thereof, and include perforations therethrough for fluid flow. In some embodiments the inlet retaining feature 150 is constructed of the same material as the outlet retaining feature 152. In some other embodiments the inlet retaining feature 150 is constructed of a different material than the outlet retaining feature 152.

The inlet and outlet retaining features 150, 152 may be connected to the inlet and outlet cassette plates 114, 120, respectively, using a weld, adhesive, or mechanical attachment. For example, the inlet and outlet retaining features 150, 152 may include one or more apertures around the perimeter of the inlet and outlet retaining features 150, 152, and each aperture may be melted to a boss on the respective cassette plates 114, 120.

The cassette assembly 110 can further include a separation layer seal 146 (FIGS. 2-4, 6 and 7). The separation layer seal 146 is generally configured to seal among the separation layer and each of the inlet cassette plate 114 and the outlet cassette plate 120 so that fluid does not escape from between the plates during fluid filtration. The separation layer seal 146 can be installed between the inlet cassette plate 114 and the outlet cassette plate 120. In some embodiments, the separation layer seal 146 can be in contact with the inlet cassette plate 114 and the outlet cassette plate 120. The separation layer seal 146 can be configured to fluidically seal a perimeter region 130a of the separation layer 130 (partially visible in FIG. 2), a perimeter region 136a (FIG. 3) of the inlet channel 136, and a perimeter region 138a (FIG. 2) of the outlet channel 138. In some embodiments, the separation layer seal 146 is defined by a relatively tight coupling of the cassette plates 114, 120 that forms a liquid tight seal via compression forces around the separation layer 130. In such an example, a separation layer seal that is a separate component than the cassette plates 114, 120 can be omitted.

The separation layer seal 146 may be constructed of a variety of different materials and combinations of materials. In various embodiments the separation layer seal 146 can be constructed of an elastomeric material such as rubber, silicone, polyurethane, and the like. In some other embodiments, the separation layer seal 146 is a molded plastic. In yet other embodiments, the separation layer seal 146 is a metal. In one example, the separation layer seal 146 is injection-molded, 3D printed or formed through other types of processes. The separation layer seal 146 can include an overmolded gasket. The overmolded gasket can be injection molded around the perimeter of the separation layer 130 to form the separation layer seal 146.

In alternative embodiments, the separation layer seal can be more than one seal. The separation layer seal 146 can include a first o-ring inserted between the perimeter region 130a on the first lateral surface 134 (such as the upstream surface) of the separation layer 130 and the inlet cassette plate 114. The separation layer seal 146 can include a second o-ring inserted between the perimeter region 130a on a second lateral surface 135 (such as the downstream surface) of the separation layer 130 and the outlet cassette plate 120. In further alternative embodiments, the separation layer seal 146 may be a weld, for example, or an adhesive. A weld may be formed between, or an adhesive may be used to seal together, the cassette plates 114, 120, or the separation layer 130 and the inlet cassette plate 114, or the separation layer 130 and the outlet cassette plate 120, or any combination thereof.

As illustrated in FIG. 5, in some embodiments, the inlet cassette plate 114 and the outlet cassette plate 120 can mutually define a compression structure 147 around the inlet channel 136 and the outlet channel 138. More particularly, in the current example the outlet cassette plate 120 defines an axially extending sidewall 147a around the outlet channel 138 that faces an opposing sidewall 147b of the inlet cassette plate 114 that surrounds the inlet channel 136. The axially extending sidewall 147a and the opposing sidewall 147b exert a compression force on the perimeter region 130a of the separation layer 130 that creates a fluid seal. The compression structure 147 may advantageously prevent fluid bypass therethrough.

The cassette assembly 110 can further include an attachment seal 158 (FIGS. 2-4, 6, and 7). The attachment seal 158 is generally configured to fluidically seal between the inlet and outlet cassette plates 114, 120. The attachment seal 158 can be inserted between the inlet cassette plate 114 and the outlet cassette plate 120. The attachment seal 158 can extend laterally around and outside of a periphery of the separation layer 130. The attachment seal 158 can be positioned laterally between the axial surfaces 115a, 115b (FIG. 1) of the inlet and outlet cassette plates 114, 120, respectively, and the separation layer seal 146. The attachment seal 158 can be constructed of a variety of different materials and combinations of materials consistent with those discussed above with reference to the separation layer seal. The attachment seal 158 may be retained with friction and/or compression forces, for example, and/or may be retained using the fastener 172. Such forces can be among the attachment seal 158, the inlet cassette plate 114 and the outlet cassette plate 120.

Cassette assemblies consistent with the technology disclosed herein can have a variety of different configurations. FIGS. 6-8 depict perspective views of another example cassette assembly 210, and FIGS. 6-8 can be viewed together with the following description. The cassette assembly 210 is generally configured to filter a fluid that is passed therethrough. The cassette assembly 210 generally has an inlet cassette plate 214, an outlet cassette plate 220, and a separation layer 230. It will be understood the components referenced in the description of FIGS. 6-8 herein are consistent with the descriptions of the same components described elsewhere herein unless contradictory to the current description or corresponding figures.

Similar to other embodiments described herein, cassette assembly 210 has an inlet cassette plate 214, an outlet cassette plate 220, and a separation layer 230 disposed between the inlet cassette plate 214 and the outlet cassette plate 220. The outlet cassette plate 220 can be configured to be arranged in a stack with the inlet cassette plate 214. The inlet cassette plate 214 can define an inlet flow path 216 and an inlet cassette vent 224. The inlet flow path 216 defines a path for inlet fluid flow into the cassette assembly 210 during a fluid filtration application. The inlet cassette vent 224 defines a path for gas to flow out of the cassette assembly 210 during a fluid filtration application. The inlet cassette vent 224 can be open or closed to an ambient environment. The inlet flow path 216 can define an axial through-hole which extends axially through the inlet cassette plate 214. The inlet cassette vent 224 can similarly extend axially through the inlet cassette plate 214.

The outlet cassette plate 220 can define an outlet flow path 218 and an outlet cassette vent 222. The outlet flow path 218 defines a path for outlet fluid flow during a fluid filtration application. The outlet cassette vent 222 defines a path for gas to flow out of the outlet cassette plate 220 during a fluid filtration application. The outlet flow path 218 can define an axial through-hole which extends axially through the outlet cassette plate 220. The outlet cassette vent 222 can similarly extend axially through the outlet cassette plate 220. The outlet cassette vent 222 can be open or closed to the ambient environment. The outlet flow path 218 can be generally configured for fluid communication with the inlet flow path 216.

In various embodiments, the inlet flow path 216 and the outlet flow path 218 are in fluid communication via the separation layer 230 of the cassette assembly 210. The separation layer 230 is disposed between the inlet cassette plate 214 and the outlet cassette plate 220. The separation layer 230 is generally configured to filter a fluid stream flowing from the inlet flow path 216 to the outlet flow path 218. The inlet flow path 216 can be configured to be in fluid communication with the outlet flow path 218 through the separation layer 230. The separation layer 230 can include a membrane stack, which can further include a plurality of membrane layers, as described herein with respect to FIGS. 1-5.

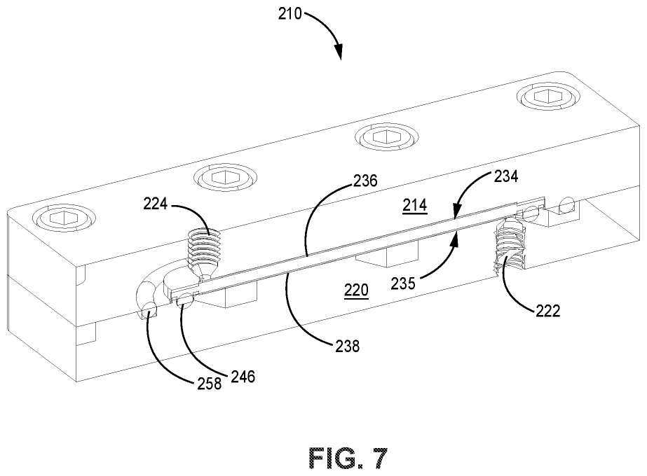

Each cassette assembly 210 can further include an inlet channel 236 (as illustrated in FIG. 7) and an outlet channel 238 (as illustrated in FIG. 7). The inlet channel 236 generally defines a path for fluid flow from the inlet flow path 216 along a first lateral surface 234 of the separation layer 230 (FIG. 7). The outlet channel 238 generally defines a path for fluid flow along a second lateral surface 235 (FIG. 7) of the separation layer 230, which is opposite the first lateral surface 234. The outlet channel 238 extends from the separation layer 230 to the outlet flow path 218.

The inlet channel 236 extends along an effective inlet surface area (not shown) of the separation layer 230. The “effective inlet surface area” is defined as the surface area of the upstream surface of the separation layer 230, which is the first lateral surface 234, that is directly exposed to the inlet channel 236. The inlet channel 236 is similar to the inlet channel 136 described herein with respect to FIGS. 1-5. The outlet channel 238 extends along an effective outlet surface area (not shown) of the separation layer 230. The “effective outlet surface area” is defined as the surface area of the downstream surface of the separation layer 230, which is the second lateral surface 235, that is exposed to the outlet channel 238. The outlet channel 238 is similar to the outlet channel 138 described herein with respect to FIGS. 1-5.

The inlet channel 236 of the inlet cassette plate 214 defines an inlet channel length L1 and an inlet channel width W1, as illustrated in FIG. 3. In some embodiments, the ratio of the inlet channel length L1 to the inlet channel width W1 may advantageously result in a relative improvement in flow characteristics in filtration operations. The inlet channel length L1 can be between 1 and 4 times larger than the inlet channel width W1. In alternative embodiments, the inlet channel length L1 can be at least 1 time, at least 1.5 times, at least 2 times, at least 2.5 times, at least 3 times, at least 3.5 times, at least 4 times the inlet channel width W1, etc., and/or can be less than 4 times, less than 3.75 times, less than 3.25 times, less than 2.75 times, less than 2.25 times, less than 1.75 times, less than 1.25 times the inlet channel width W1, etc.

The outlet channel 238 of the outlet cassette plate 220 can define an outlet channel length L2 and an outlet channel width W2, as illustrated in FIG. 2. The outlet channel length L2 can have a ratio with the outlet channel width W2 consistent with that discussed above with respect to the inlet channel length L1 and the inlet channel width W1.

The cassette assembly 210 may further include an assembly inlet 210a (FIG. 6) and an assembly outlet 210b (FIG. 8). The inlet cassette plate 214 can be configured to fluidically couple the assembly inlet 210a and the inlet channel 236. The outlet cassette plate 220 can be configured to fluidically couple the assembly outlet 210b and the outlet channel 238.

The separation layer 230 generally defines an effective inlet surface area 232a and an effective outlet surface area 232b (FIG. 8). The effective inlet surface area 232a has an effective length L4 and an effective width W4 (FIGS. 2 and 5). The effective inlet surface area 232a can be defined as the area of the separation layer 230 which is available for filtration. The effective inlet surface area 232a will generally be less than a total surface area of the separation layer 230. The separation layer can define a total length L3 (FIG. 2) and a total width W3 (FIG. 2). In the current example, a perimeter region of the separation layer 230 is pinched between the inlet plate 214 and the outlet cassette plate 220 and is not available for filtration, and thus does not define a portion of the effective area.

The effective length L4 can be between 1 times and 4 times larger than the effective width W4. In alternative embodiments, the effective length L4 can be at least 1 times, at least 1.5 times, at least 2 times, at least 2.5 times, at least 3 times, at least 3.5 times, or at least 4 times the effective width W4, etc. In alternative embodiments, the effective length L4 can be less than 4 times, less than 3.75 times, less than 3.25 times, less than 2.75 times, less than 2.25 times, less than 1.75 times, or less than 1.25 times the effective width W4, etc.

In some embodiments, the effective width W4 is equal to the width of the effective inlet surface area 232a and the width of the effective outlet surface area 232b. In alternative embodiments, the effective width W4 may be different at the effective inlet surface area 232a from the effective outlet surface area 232b such that there is an inlet effective width and an outlet effective width (not shown). In some embodiments, the effective length L4 is equal to the length of the effective inlet surface area 232a and the length of the effective outlet surface area 232b. In alternative embodiments, the effective length L4 of the effective inlet surface area 232a may be different than the effective length of the effective outlet surface area 232b such that there is an inlet effective length and an outlet effective length (not shown).

Each cassette assembly 210 can further include one or more channel spacers that are each configured to be received by the inlet channel 236 and/or the outlet channel 238 as described with respect to FIGS. 1-5.

Each cassette assembly 210 can further include a separation layer seal 246 (FIG. 7). The separation layer seal 246 is generally configured to seal among the separation layer and each of the inlet cassette plate 214 and the outlet cassette plate 220 so that fluid does not escape from between the plates during fluid filtration. The separation layer seal 246 can be installed between the inlet cassette plate 214 and the outlet cassette plate 220. In some embodiments, the separation layer seal 246 can be in contact with the inlet cassette plate 214 and the outlet cassette plate 220. The separation layer seal 246 can be configured to fluidically seal a perimeter region of the separation layer 230 (not shown), a perimeter region of the inlet channel 236 (not shown), and a perimeter region of the outlet channel 238 (not shown). The separation layer seal 246 may be similar to the separation layer seal 146 described with respect to FIGS. 1-5.

The cassette assembly 210 can further include an attachment seal 258. The attachment seal 258 is generally configured to fluidically seal between the inlet and outlet cassette plates 214, 220. The attachment seal 258 can be inserted between the inlet cassette plate 214 and the outlet cassette plate 220. The attachment seal 258 can extend laterally around a periphery of the separation layer seal 246. The attachment seal 258 may be similar to the attachment seal 158 described with respect to FIGS. 1-5.

FIG. 10 is a schematic exploded view of some components of an alternate example cassette assembly 310 consistent with the technology disclosed herein. The cassette assembly 310 has an inlet cassette plate 314 and an outlet cassette plate 320. It will be understood the components referenced in the description of FIG. 9 herein are consistent with the descriptions of the same components described elsewhere herein unless contradictory to the current description or corresponding figures.

The outlet cassette plate 320 can include an alignment feature 352. The inlet cassette plate 314 can include a mating alignment feature 354 that is configured to mate with the alignment feature 352 when the cassette plates 314, 320 are properly aligned and stacked. The alignment feature 352 is configured to be laterally aligned with the mating alignment feature 354. “Laterally aligned” is used herein to mean that the alignment and mating alignment features overlap in the lateral direction. The lateral direction is defined as any direction orthogonal to the axial direction. The axial direction is parallel to the direction of stacking of the inlet cassette plate 114 and the outlet cassette plate 120. The alignment feature 352 and the mating alignment feature 354 can assist in operatively coupling the outlet cassette plate 320 and the inlet cassette plate 314. The alignment feature 352 and the mating alignment feature 354 can advantageously guide a user to correctly stack the various cassette plates to assemble the cassette. In some embodiments, the alignment feature 352 may include a protrusion and the mating alignment feature may include a receptacle that is configured to receive the protrusion, although the reverse configuration is also contemplated. In some alternative embodiments, the alignment feature 352 may form a snap-fit with the mating alignment feature 354. In other alternative embodiments, the alignment feature 352 may include a visual indicator such as a marking that is configured to align with the mating alignment feature 354, and vice versa. In some embodiments the mating alignment feature can be integral with one of the cassette plates 314, 320. In some other embodiments, the alignment feature can be a separate component (such as a pin, screw, or the like) that is mutually received by openings defined by the outlet cassette plate 320 and the inlet cassette plate 314.

In any embodiment described herein, but discussed here with respect to FIGS. 1-5, a syringe, tube, or other implement can be used to introduce fluid to the cassette assembly 110. Such implements may include mating components such as, for example, a luer lock, that is configured to sealably engage one or both of the assembly inlet 110a and the assembly outlet 110b. In alternative embodiments, the assembly inlet 110a and the assembly outlet 110b can be configured to mate with, for example, tubing of various sizes, syringes or needles, etc. In further alternative embodiments, the assembly inlet 110a and the assembly outlet 110b can be configured to be closeable or sealable and can be further configured to be reopened or unsealed.

The cassette assembly 110 can further include a fastener 172 (FIG. 1). The fastener 172 is generally configured to retain the components of the cassette assembly 110 in an operative configuration. The fastener 172 can be configured to operatively couple the inlet cassette plate 114 and the outlet cassette plate 120. In the current example, the fastener 172 includes a bolt (not shown). In some embodiments, the inlet cassette plate 114 can define a first axial through-hole 176 (FIG. 2). The outlet cassette plate 120 can define a second axial through-hole 178 (FIG. 2). The first axial through-hole 176 and the second axial through-hole 178 can be configured to laterally align with one another to receive the bolt. There may be more than one bolt, and respectively there may be more than one laterally aligned first and second through-holes 176, 178 to receive the more than one bolt. In some embodiments, at least one of the first and second axial through-holes 176, 178 may include a threaded hole that is configured to engage the bolt.

The cassette assembly 110 has fasteners 172 that include a plurality of bolts, where each bolt has a first nut 184 and a second nut (not shown). The first nut 184 can be configured to receive a first end of the bolt. The second nut can be configured to receive an opposite, second end of the bolt. The first and second nuts can be configured to apply a compression force to the cassette assembly 110. The nuts can specifically apply the compression force to the operatively coupled cassette plates 114, 120 via the bolt. The first nut 184 can be in contact with the inlet cassette plate 114, and the second nut can be in contact with the outlet cassette plate 120, or vice versa. Thus, the nuts can apply the compression force to the cassette plates 114, 120. This may advantageously seal the fluid flow path through the cassette assembly 110. In alternative embodiments, the fastener 172 may include various clamps, bolts, snap-fits, ties, etc., that can apply the compression force as described herein.

In further alternative embodiments, and as illustrated in FIGS. 6-8 the fastener 272 may include at least one threaded bolt 274 which threadably engages with the at least one threaded hole 276 defined by at least one of the inlet cassette plate 114 and the outlet cassette plate 120. In embodiments with the at least one threaded bolt 274 engaged with the at least one threaded hole 276, at least one of the first and second nuts may not be necessary. The at least one of the first and second nuts may not be necessary because of the threaded engagement between the threaded bolt and the threaded hole. Instead, only a first nut 284 is required opposite the side of the threaded hole 276.

Returning again to FIG. 8, the inlet cassette plate 314 can define a first axial through-hole 376. The outlet cassette plate 320 can define a second axial through-hole 378. The first axial through-hole 376 and the second axial through-hole 378 can be configured to laterally align with one another to receive a fastener such as a pin, screw, bolt (not shown). There may be more than one fastener, and respectively there may be more than one pair of laterally aligned through-holes, which each are configured to receive a fastener. The fastener can be configured to operatively couple the inlet cassette plate 314 and the outlet cassette plate 320. Each of the first and second axial through-holes can be configured to be laterally aligned with one another to receive the fastener.

### Exemplary Aspects

Aspect 1. A cassette assembly comprising:
an inlet cassette plate defining an inlet flow path and an inlet channel extending from the inlet flow path;
an outlet cassette plate configured to be arranged in a stack with the inlet cassette plate, the outlet cassette plate defining an outlet flow path and an outlet channel extending from the outlet flow path;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path,
wherein the inlet channel defines an effective inlet surface area of the separation layer and the outlet channel defines an effective outlet surface area of the separation layer, and wherein the effective inlet surface area defines a first width towards the first lateral end and a second width towards the second lateral end, and wherein the first width is less than the second width.

Aspect 2. The cassette assembly of any one of aspects 1 and 3-25, wherein the inlet channel extends from an inlet intermediate position between the first lateral end and the second lateral end towards the second lateral end.

Aspect 3. The cassette assembly of any one of aspects 1-2 and 4-25, wherein the outlet channel extends from an outlet intermediate position between the first lateral end and the second lateral end towards the first lateral end.

Aspect 4. The cassette assembly of any one of aspects 1-3 and 5-25, wherein the width of the effective inlet surface area tapers from the first width to the second width.

Aspect 5. The cassette assembly of any one of aspects 1-4 and 6-25, further comprising: a flow guide positioned within the inlet channel towards the first lateral end, wherein the flow guide defines the first width.

Aspect 6. The cassette assembly of aspect 5, wherein the flow guide tapers from the first width to the second width.

Aspect 7. The cassette assembly of aspect 5, wherein the inlet cassette plate defines the second width.

Aspect 8. The cassette assembly of any one of aspects 1-7 and 9-25, wherein the inlet flow path has an inlet opening that defines an interface between the inlet flow path and the inlet channel, and wherein the inlet opening defines an elongate slot across the first width.

Aspect 9. The cassette assembly of any one of aspects 1-8 and 10-25, wherein the inlet flow path has an inlet opening that defines an interface between the inlet flow path and the inlet channel, and wherein the inlet opening is circular.

Aspect 10. The cassette assembly of any one of aspects 1-9 and 11-25, wherein the outlet flow path has an outlet opening that defines an interface between the outlet flow path and the outlet channel, and wherein the outlet opening defines an elongate slot across the first width.

Aspect 11. The cassette assembly of any one of aspects 1-10 and 12-25 wherein the outlet flow path has an outlet opening that defines an interface between the outlet flow path and the outlet channel, and wherein the outlet opening is circular.

Aspect 12. The cassette assembly of any one of aspects 1-11 and 13-25, further comprising an assembly inlet, wherein the inlet flow path defines an axial through-hole, and wherein the inlet cassette plate is configured to fluidically couple the assembly inlet and the inlet channel.

Aspect 13. The cassette assembly of any one of aspects 1-12 and 14-25, further comprising an assembly outlet, wherein the outlet flow path defines an axial through-hole, and wherein the outlet cassette plate is configured to fluidically couple the assembly outlet and the outlet channel.

Aspect 14. The cassette assembly of any one of aspects 1-13 and 15-25, further comprising an inlet retaining feature configured to cover an inlet opening of the inlet flow path, wherein the inlet opening defines an interface between the inlet flow path and the inlet channel.

Aspect 15. The cassette assembly of any one of aspects 1-14 and 16-25, further comprising an outlet retaining feature configured to cover an outlet opening of the outlet flow path, wherein the outlet opening defines an interface between the outlet flow path and the outlet channel.

Aspect 16. The cassette assembly of any one of aspects 1-15 and 17-25, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

Aspect 17. The cassette assembly of any one of aspects 1-16 and 18-25, wherein the separation layer seal comprises an overmolded gasket.

Aspect 18. The cassette assembly of any one of aspects 1-17 and 19-25, wherein the separation layer comprises a membrane stack further comprising a plurality of membrane layers, and wherein the plurality of membrane layers comprises at least 10 membrane layers.

Aspect 19. The cassette assembly of any one of aspects 1-18 and 20-25, wherein the separation layer has an effective inlet surface area defined by an effective length and an effective width, and wherein the effective length is at least 2.5 times the effective width.

Aspect 20. The cassette assembly of any one of aspects 1-19 and 21-25, further comprising: an outlet channel spacer positioned in the outlet channel, wherein the outlet channel spacer is configured to accommodate fluid flow.

Aspect 21. The cassette assembly of any one of aspects 1-20 and 22-25, further comprising: an inlet channel spacer positioned in the inlet channel, wherein the inlet channel spacer is configured to accommodate fluid flow.

Aspect 22. The cassette assembly of any one of aspects 1-21 and 23-25, wherein at least one of the inlet channel spacer and the outlet channel spacer comprises lateral ridges extending across the separation layer.

Aspect 23. The cassette assembly of any one of aspects 1-22 and 24-25, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

Aspect 24. The cassette assembly of any one of aspects 1-23 and 25-25, further comprising a fastener configured to operatively couple the inlet cassette plate and the outlet cassette plate.

Aspect 25. The cassette assembly of any one of aspects 1-24 and 26-25,
wherein the fastener comprises a bolt, and
wherein the inlet cassette plate defines a first axial through-hole, and the outlet cassette plate defines a second axial through-hole, wherein the first axial through-hole and the second axial through-hole are configured to laterally align to receive the bolt, and
wherein the cassette assembly further comprises a first nut configured to receive one end of the bolt and a second nut configured to receive an opposite end of the bolt, and wherein the first and second nuts are configured to apply a compression force to the cassette assembly.

Aspect 26. The cassette assembly of any one of aspects 1-25, further comprising an attachment seal between the inlet cassette plate and the outlet cassette plate, wherein the attachment seal extends laterally around and outside of a periphery of the separation layer.

Aspect 27. A cassette assembly comprising:
an inlet cassette plate defining an inlet flow path, an inlet channel in fluid communication with the inlet flow path, and an inlet opening defining an interface between the inlet flow path and the inlet channel;
an outlet cassette plate configured to be arranged in a stack with the inlet cassette plate, the outlet cassette plate defining an outlet flow path and an outlet channel in fluid communication with the outlet flow path;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path; and
an inlet retaining feature extending across the inlet opening of the inlet flow path.

Aspect 28. The cassette assembly of any one of aspects 27 and 29-51, wherein the inlet channel extends from an inlet intermediate position between the first lateral end and the second lateral end towards the second lateral end.

Aspect 29. The cassette assembly of any one of aspects 27-28 and 30-51, wherein the outlet channel extends from an outlet intermediate position between the first lateral end and the second lateral end towards the first lateral end.

Aspect 30. The cassette assembly of any one of aspects 27-29 and 31-51, wherein the width of the effective inlet surface area tapers from the first width to the second width.

Aspect 31. The cassette assembly of any one of aspects 27-30 and 32-51, further comprising: a flow guide positioned within the inlet channel towards the first lateral end, wherein the flow guide defines the first width.

Aspect 32. The cassette assembly of aspect 31, wherein the flow guide tapers from the first width to the second width.

Aspect 33. The cassette assembly of aspect 31, wherein the inlet cassette plate defines the second width.

Aspect 34 The cassette assembly of any one of aspects 27-33 and 34-51, wherein the inlet flow path has an inlet opening that defines an interface between the inlet flow path and the inlet channel, and wherein the inlet opening defines an elongate slot across the first width.

Aspect 35. The cassette assembly of any one of aspects 27-34 and 36-51, wherein the inlet flow path has an inlet opening that defines an interface between the inlet flow path and the inlet channel, and wherein the inlet opening is circular.

Aspect 36. The cassette assembly of any one of aspects 27-35 and 37-51, wherein the outlet flow path has an outlet opening that defines an interface between the outlet flow path and the outlet channel, and wherein the outlet opening defines an elongate slot across the first width.

Aspect 37. The cassette assembly of any one of aspects 27-36 and 38-51, wherein the outlet flow path has an outlet opening that defines an interface between the outlet flow path and the outlet channel, and wherein the outlet opening is circular.

Aspect 38. The cassette assembly of any one of aspects 27-37 and 39-51, further comprising an assembly inlet, wherein the inlet flow path defines an axial through-hole, and wherein the inlet cassette plate is configured to fluidically couple the assembly inlet and the inlet channel.

Aspect 39. The cassette assembly of any one of aspects 27-38 and 40-51, further comprising an assembly outlet, wherein the outlet flow path defines an axial through-hole, and wherein the outlet cassette plate is configured to fluidically couple the assembly outlet and the outlet channel.

Aspect 40. The cassette assembly of any one of aspects 27-39 and 41-51, further comprising an outlet retaining feature configured to cover an outlet opening of the outlet flow path, wherein the outlet opening defines an interface between the outlet flow path and the outlet channel.

Aspect 41. The cassette assembly of any one of aspects 27-40 and 42-51, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

Aspect 42. The cassette assembly of any one of aspects 27-41 and 43-51, wherein the separation layer seal comprises an overmolded gasket.

Aspect 43. The cassette assembly of any one of aspects 27-42 and 44-51, wherein the separation layer comprises a membrane stack further comprising a plurality of membrane layers, and wherein the plurality of membrane layers comprises at least 10 membrane layers.

Aspect 44. The cassette assembly of any one of aspects 27-43 and 45-51, wherein the separation layer has an effective inlet surface area defined by an effective length and an effective width, and wherein the effective length is at least 2.5 times the effective width.

Aspect 45. The cassette assembly of any one of aspects 27-44 and 46-51, further comprising: an outlet channel spacer positioned in the outlet channel, wherein the outlet channel spacer is configured to accommodate fluid flow.

Aspect 46. The cassette assembly of any one of aspects 27-45 and 47-51, further comprising: an inlet channel spacer positioned in the inlet channel, wherein the inlet channel spacer is configured to accommodate fluid flow.

Aspect 47. The cassette assembly of any one of aspects 27-46 and 48-51, wherein at least one of the inlet channel spacer and the outlet channel spacer comprises lateral ridges extending across the separation layer.

Aspect 48. The cassette assembly of any one of aspects 27-47 and 49-51, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

Aspect 49. The cassette assembly of any one of aspects 27-48 and 50-51, further comprising a fastener configured to operatively couple the inlet cassette plate and the outlet cassette plate.

Aspect 50. The cassette assembly of any one of aspects 27-49 and 51, wherein the fastener comprises a bolt, and wherein the inlet cassette plate defines a first axial through-hole, and the outlet cassette plate defines a second axial through-hole, wherein the first axial through-hole and the second axial through-hole are configured to laterally align to receive the bolt, and wherein the cassette assembly further comprises a first nut configured to receive one end of the bolt and a second nut configured to receive an opposite end of the bolt, and wherein the first and second nuts are configured to apply a compression force to the cassette assembly.

Aspect 51. The cassette assembly of any one of aspects 27-50, further comprising an attachment seal between the inlet cassette plate and the outlet cassette plate, wherein the attachment seal extends laterally around and outside of a periphery of the separation layer.

Aspect 52. A cassette assembly comprising:
an inlet cassette plate defining an inlet flow path, an inlet channel in fluid communication with the inlet flow path, and an inlet opening defining an interface between the inlet flow path and the inlet channel, wherein the inlet opening is an elongate slot;
an outlet cassette plate configured to be arranged in a stack with the inlet cassette plate, the outlet cassette plate defining an outlet flow path, an outlet channel in fluid communication with the outlet flow path, and an outlet opening defining an interface between the outlet flow path and the outlet channel;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path,
wherein the inlet channel defines an effective inlet surface area of the separation layer, the outlet channel defines an effective outlet surface area of the separation layer, and the inlet opening extends laterally along a width of the effective inlet surface area.

Aspect 53. The cassette assembly of any one of aspects 52 and 54-75, wherein the inlet channel extends from an inlet intermediate position between the first lateral end and the second lateral end towards the second lateral end.

Aspect 54. The cassette assembly of any one of aspects 52-53 and 55-75, wherein the outlet channel extends from an outlet intermediate position between the first lateral end and the second lateral end towards the first lateral end.

Aspect 55. The cassette assembly of any one of aspects 52-54 and 56-75, wherein the width of the effective inlet surface area tapers from the first width to the second width.

Aspect 56. The cassette assembly of any one of aspects 52-55 and 57-75, further comprising: a flow guide positioned within the inlet channel towards the first lateral end, wherein the flow guide defines the first width.

Aspect 57. The cassette assembly of aspect 56, wherein the flow guide tapers from the first width to the second width.

Aspect 58. The cassette assembly of aspect 56, wherein the inlet cassette plate defines the second width.

Aspect 59. The cassette assembly of any one of aspects 52-58 and 59-75, wherein the outlet flow path has an outlet opening that defines an interface between the outlet flow path and the outlet channel, and wherein the outlet opening defines an elongate slot across the first width.

Aspect 60. The cassette assembly of any one of aspects 52-59 and 61-75, wherein the outlet flow path has an outlet opening that defines an interface between the outlet flow path and the outlet channel, and wherein the outlet opening is circular.

Aspect 61. The cassette assembly of any one of aspects 52-60 and 62-75, further comprising an assembly inlet, wherein the inlet flow path defines an axial through-hole, and wherein the inlet cassette plate is configured to fluidically couple the assembly inlet and the inlet channel.

Aspect 62. The cassette assembly of any one of aspects 52-61 and 63-75, further comprising an assembly outlet, wherein the outlet flow path defines an axial through-hole, and wherein the outlet cassette plate is configured to fluidically couple the assembly outlet and the outlet channel.

Aspect 63. The cassette assembly of any one of aspects 52-62 and 63-75, further comprising an inlet retaining feature configured to cover an inlet opening of the inlet flow path, wherein the inlet opening defines an interface between the inlet flow path and the inlet channel.

Aspect 64. The cassette assembly of any one of aspects 52-63 and 65-75, further comprising an outlet retaining feature configured to cover an outlet opening of the outlet flow path, wherein the outlet opening defines an interface between the outlet flow path and the outlet channel.

Aspect 65. The cassette assembly of any one of aspects 52-64 and 66-75, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

Aspect 66. The cassette assembly of any one of aspects 52-65 and 67-75, wherein the separation layer seal comprises an overmolded gasket.

Aspect 67. The cassette assembly of any one of aspects 52-66 and 68-75, wherein the separation layer comprises a membrane stack further comprising a plurality of membrane layers, and wherein the plurality of membrane layers comprises at least 10 membrane layers.

Aspect 68. The cassette assembly of any one of aspects 52-67 and 69-75, wherein the separation layer has an effective inlet surface area defined by an effective length and an effective width, and wherein the effective length is at least 2.5 times the effective width.

Aspect 69. The cassette assembly of any one of aspects 52-68 and 70-75, further comprising: an outlet channel spacer positioned in the outlet channel, wherein the outlet channel spacer is configured to accommodate fluid flow.

Aspect 70. The cassette assembly of any one of aspects 52-69 and 71-75, further comprising: an inlet channel spacer positioned in the inlet channel, wherein the inlet channel spacer is configured to accommodate fluid flow.

Aspect 71. The cassette assembly of any one of aspects 52-70 and 72-75, wherein at least one of the inlet channel spacer and the outlet channel spacer comprises lateral ridges extending across the separation layer.

Aspect 72. The cassette assembly of any one of aspects 52-71 and 73-75, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

Aspect 73. The cassette assembly of any one of aspects 52-72 and 73-75, further comprising a fastener configured to operatively couple the inlet cassette plate and the outlet cassette plate.

Aspect 74. The cassette assembly of any one of aspects 52-73 and 75, wherein the fastener comprises a bolt, and wherein the inlet cassette plate defines a first axial through-hole, and the outlet cassette plate defines a second axial through-hole, wherein the first axial through-hole and the second axial through-hole are configured to laterally align to receive the bolt, and wherein the cassette assembly further comprises a first nut configured to receive one end of the bolt and a second nut configured to receive an opposite end of the bolt, and wherein the first and second nuts are configured to apply a compression force to the cassette assembly.

Aspect 75. The cassette assembly of any one of aspects 52-74, further comprising an attachment seal between the inlet cassette plate and the outlet cassette plate, wherein the attachment seal extends laterally around and outside of a periphery of the separation layer.

It should be noted that, as used in this specification and the appended claims, the phrase “configured” describes a system, apparatus, or other structure that is constructed to perform a particular task or adopt a particular configuration. The word “configured” can be used interchangeably with similar words such as “arranged,” “constructed,” “manufactured,” and the like.

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure. These terms are used only to simplify the description, however, and not to limit the interpretation of any embodiment described.

Further, it is understood that the description of any particular element as being connected to or coupled to another element can be directly connected or coupled, or indirectly coupled/connected via intervening elements.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

The foregoing description of the example embodiments has been presented for the purposes of illustration and description. It is not intended to be exhaustive or to limit the embodiments to the precise form disclosed. Modifications and variations are possible in light of the above teaching. Any or all features of the disclosed embodiments can be applied individually or in any combination and are not meant to be limiting, but purely illustrative. It is to be understood that the above description is intended to be illustrative, and not restrictive, and the claims are not limited to the illustrative embodiments as set forth herein.

What is claimed is:

1. A cassette assembly comprising:
an inlet cassette plate defining an inlet flow path and an inlet channel extending from the inlet flow path;
an outlet cassette plate configured to be arranged in a stack with the inlet cassette plate, the outlet cassette plate defining an outlet flow path and an outlet channel extending from the outlet flow path;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path,
wherein the inlet channel defines an effective inlet surface area of the separation layer and the outlet channel defines an effective outlet surface area of the separation layer, and wherein the effective inlet surface area defines a first width towards the first lateral end and a second width towards the second lateral end, and wherein the first width is less than the second width.

2. A cassette assembly comprising:
an inlet cassette plate defining an inlet flow path, an inlet channel in fluid communication with the inlet flow path, and an inlet opening defining an interface between the inlet flow path and the inlet channel;
an outlet cassette plate configured to be arranged in a stack with the inlet cassette plate, the outlet cassette plate defining an outlet flow path and an outlet channel in fluid communication with the outlet flow path;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path; and
an inlet retaining feature extending across the inlet opening of the inlet flow path.

3. The cassette assembly of claim 2, wherein the inlet channel extends from an inlet intermediate position between the first lateral end and the second lateral end towards the second lateral end.

4. The cassette assembly of claim 2, wherein the outlet channel extends from an outlet intermediate position between the first lateral end and the second lateral end towards the first lateral end.

5. The cassette assembly of claim 2, wherein the inlet channel defines an effective inlet surface area of the separation layer and the outlet channel defines an effective outlet surface area of the separation layer.

6. The cassette assembly of claim 5, wherein the effective inlet surface area defines a first width towards the first lateral end and a second width towards the second lateral end, wherein the first width is less than the second width, and wherein the effective inlet surface area tapers from the first width to the second width.

7. The cassette assembly of claim 6, further comprising: a flow guide positioned within the inlet channel towards the first lateral end, wherein the flow guide defines the first width, wherein the flow guide tapers from the first width to the second width, and wherein the inlet cassette plate defines the second width.

8. The cassette assembly of claim 6, wherein the inlet flow path has an inlet opening that defines an interface between the inlet flow path and the inlet channel, and wherein the inlet opening defines one of an elongate slot across the first width or a circular shape.

9. The cassette assembly of claim 6, wherein the outlet flow path has an outlet opening that defines an interface between the outlet flow path and the outlet channel, and wherein the outlet opening defines one of an elongate slot across the first width or a circular shape.

10. The cassette assembly of claim 2, further comprising an assembly inlet, wherein the inlet flow path defines an axial through-hole, and wherein the inlet cassette plate is configured to fluidically couple the assembly inlet and the inlet channel.

11. The cassette assembly of claim 2, further comprising an assembly outlet, wherein the outlet flow path defines an axial through-hole, and wherein the outlet cassette plate is configured to fluidically couple the assembly outlet and the outlet channel.

12. The cassette assembly of claim 2, further comprising an outlet retaining feature configured to cover an outlet opening of the outlet flow path, wherein the outlet opening defines an interface between the outlet flow path and the outlet channel.

13. The cassette assembly of claim 2, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

14. The cassette assembly of claim 2, wherein the separation layer comprises a membrane stack further comprising a plurality of membrane layers, and wherein the plurality of membrane layers comprises at least 10 membrane layers.

15. The cassette assembly of claim 2, further comprising:
an outlet channel spacer positioned in the outlet channel, wherein the outlet channel spacer is configured to accommodate fluid flow.

16. The cassette assembly of claim 2, further comprising:
an inlet channel spacer positioned in the inlet channel, wherein the inlet channel spacer is configured to accommodate fluid flow.

17. The cassette assembly of claim 2, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

18. The cassette assembly of claim 2, further comprising a fastener configured to operatively couple the inlet cassette plate and the outlet cassette plate.

19. The cassette assembly of claim 2, further comprising an attachment seal between the inlet cassette plate and the outlet cassette plate, wherein the attachment seal extends laterally around and outside of a periphery of the separation layer.

20. A cassette assembly comprising:
an inlet cassette plate defining an inlet flow path, an inlet channel in fluid communication with the inlet flow path, and an inlet opening defining an interface between the inlet flow path and the inlet channel, wherein the inlet opening is an elongate slot;
an outlet cassette plate configured to be arranged in a stack with the inlet cassette plate, the outlet cassette plate defining an outlet flow path, an outlet channel in fluid communication with the outlet flow path, and an outlet opening defining an interface between the outlet flow path and the outlet channel;
a separation layer disposed between the inlet cassette plate and the outlet cassette plate and extending from a first lateral end to a second lateral end, wherein the inlet flow path is configured to be in fluid communication with the outlet flow path through the separation layer to form an assembly flow path,
wherein the inlet channel defines an effective inlet surface area of the separation layer, the outlet channel defines an effective outlet surface area of the separation layer, and the inlet opening extends laterally along a width of the effective inlet surface area.
